(19) United States
(12) Patent Application Publication
(10) Pub. No.: US 2015/0165717 A1
(43) Pub. Date: Jun. 18, 2015

(54) APPARATUS AND METHOD FOR DISPENSING CUSHIONING WRAP MATERIAL

(71) Applicant: Ranpak Corp., Concord Township, OH (US)

(72) Inventors: Brandon Cadette Page, Durham, NC (US); Marcelo Miller Passos, Morrisville, NC (US); Matthew Scott Gardner, Four Oaks, NC (US)

(21) Appl. No.: 14/415,724

(22) PCT Filed: Jul. 16, 2013
(86) PCT No.: PCT/US2013/050672

§ 371 Date: Jan. 19, 2015

Related U.S. Application Data
(60) Provisional application No. 61/673,278, filed on Jul. 19, 2012.

(51) Int. Cl. B31D 5/00

(52) U.S. Cl. CPC B31D 5/0065; B31D 2205/0047; B31D 2205/0023; B31D 2205/0058

(57) ABSTRACT

An unpowered, manually operable apparatus (10) for dispensing cushioning wrap material (13) includes a frame (12), a roll (14) of interleaf material (16) rotatably secured to the frame, a roll (18) of expandable sheet material (20) in an unexpanded form rotatably secured to the frame adjacent the roll of interleaf material, and a tensioning assembly (60, 70, 80, 90) operably associated with the roll of expandable sheet material to control rotational resistance thereof. The rotational resistance causes the expandable sheet material to expand in length and thickness as it is pulled with the interleaf material by a user. Typically, the roll of interleaf material and the roll of expandable sheet material are secured to the frame such that respective longitudinal centerlines of each roll are substantially aligned. In addition, typically, the axial directions of the rolls are substantially parallel.

### RELATED APPLICATION

This application claims the benefit of and priority to U.S. Provisional Patent Application No. 61/673,278 filed Jul. 19, 2012, the disclosure of which is incorporated herein by reference as if set forth in its entirety.

### FIELD OF THE INVENTION

The present invention relates generally to packing materials and, more particularly, to packing materials for wrapping articles.

### BACKGROUND

When shipping an article from one location to another, the article is typically placed in a container along with protective packaging material to fill the voids about the article and to cushion the article during the shipping process. A common protective packaging material is a cellular foam polystyrene (e.g., STYROFOAM®, The Dow Chemical Corporation, Midland, Mich.) product having a peanut shape, and commonly referred to as “packing peanuts.” However, the performance and ecological disadvantages of plastic packing peanuts as a void fill material is well known. The plastic material is not easily biodegradable when in a landfill and, although the plastic material can be recycled through reuse, such recycling programs have met with limited success. Moreover, articles within a package and surrounded by plastic packing peanuts may migrate within the package. Thus, an article centered within a box when packaged, may move next to a side wall of the shipping container when transported, which may lead to damage to the article during shipment.

While a variety of products have been designed to provide a void fill substitute for plastic packing peanuts, each of the products has drawbacks. For example, starch products have been used, but tend to be excessively dusty and frangible. Products made from corn husks and other vegetation, are prone to attracting vermin, rodents, and the like.

Bubble wrap is a plastic packaging product that consists of small spheres of air bubbles. Unfortunately, bubble wrap has many negative aspects. For example, the polymer film used in bubble wrap is considered ecologically toxic because it can take hundreds of years to disintegrate in landfills. In addition, because of the air bubbles, bubble wrap is bulky and can cause storage problems.

Slit sheet paper packing material is an alternative, ecologically-friendly packing material that increases in thickness when stretched. This stretching and increase in thickness of the slit sheet paper packing material is referred to as expansion. Slit sheet paper packing material typically includes a durable paper with consecutive rows of slits cut into the paper. The thickness of the slit sheet paper packing material can increase by an order of magnitude, or more, relative to its original thickness, when stretched. This increased thickness allows the expanded material to serve as a protective cushioning wrap material for articles. Slit sheet paper packing material, and the manufacturing thereof, are described in greater detail in U.S. Pat. Nos. 5,667,871 and 5,688,578, the disclosures of which are incorporated herein by reference in their entireties. Typically, a cushion wrap material formed with expanded slit sheet packing material includes a lightweight tissue paper that acts as a separator sheet between layers of the expanded material. The tissue paper prevents openings in the expanded paper from becoming undesirably interlocked.

Traditionally, an electric powered machine is used to expand and dispense slit sheet packing material for an operator to wrap around an object or around itself. When in operation, the slit sheet packing material is expanded inside of the machine and dispensed from the front of the machine with an unexpanded separator sheet. Unfortunately, the size of these dispensing machines typically requires a large amount of table space and vertical space above the table. In addition, the weight of these dispensing machines typically prohibits the machine from being easily moved, even over short distances. Moreover, the requirement that the dispensing machine be located near a power outlet can limit the possible places that the dispensing machine can be located. Furthermore, the mechanical components of these dispensing machines eventually wear and must be replaced or repaired.

U.S. Patent Application Publication No. 2011/0309125 describes a dispensing mechanism that deploys a roll of web material having slit cuts and expands it into a web with a cellular structure. The mechanism mounts a roll of unexpanded web material on an axle that is positioned at a first angle to a guide wheel assembly. The first angle is not perpendicular to the direction of deployment and the material moves through the guide wheel assembly longitudinally in such a way that tension is applied at a second angle to the direction of deployment. This diagonal tension causes the web material to expand and form cells. However, the guide wheels that are used to apply tension to the material only contact a small portion of the material on one side. This limited and offset contact may cause uneven expansion of the slit sheet material.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, an unpowered, manually operable apparatus for dispensing cushioning wrap material includes a frame, a roll of interleaf material rotatably secured to the frame, a roll of expandable sheet material in an unexpanded form rotatably secured to the frame adjacent the roll of interleaf material, and a tensioning assembly operably associated with the roll of expandable sheet material to control rotational resistance thereof. The rotational resistance causes the expandable sheet material to expand in length and thickness as it is pulled with the interleaf material by a user. Typically, the roll of interleaf material and the roll of expandable sheet material are secured to the frame such that respective longitudinal centerlines of each roll are substantially aligned. In addition, typically, the axial directions of the rolls are substantially parallel.

In some embodiments of the present invention, the frame includes a pair of opposing brackets that extend upwardly from the frame. Each bracket has an open ended, elongated slot formed therein. The roll of interleaf material includes a hollow, axially-extending core and is rotatably secured to the frame via an elongated rod extending through the core. The elongated rod includes opposite end portions, and each end portion is received within a respective slot. The open end of each bracket slot is configured to inhibit unintentional removal of a respective rod end portion from the bracket slot.

In some embodiments of the present invention, the elongated rod includes a first pair of spaced-apart stops that limit axial movement of the rod relative to the brackets. The elongated rod also includes a second pair of spaced-apart stops located between the first pair of stops, and that are configured to limit axial movement of the roll of interleaf material supported by the rod.

In some embodiments of the present invention, the frame includes a pair of opposing supports that extend upwardly from the frame in adjacent, spaced-apart relationship with the pair of opposing brackets. The roll of expandable material is rotatably secured to the supports.

The roll of expandable sheet material includes a hollow, axially-extending core. The tension assembly includes an elongated rod with opposite end portions that extends through the hollow core. Each end portion of the elongated rod is secured to a respective one of the supports. A first core plug is attached to one end portion of the rod and includes opposite first and second end portions, and a radially outwardly directed flange adjacent the first core plug first end portion. The first core plug second end portion extends into one end of the hollow core. A second core plug is attached to an opposite end portion of the rod and includes opposite first and second end portions, and a radially outwardly directed flange adjacent the second core plug first end portion. The second core plug second end portion extends into an opposite end of the hollow core. An adjustment mechanism is operably associated with the second core plug and is configured to exert an adjustable compressive force on the roll of expandable sheet material to thereby control rotational resistance of the roll of expandable sheet material.

Typically, the width of the roll of interleaf material has a width less than a width of the expanded sheet material in an expanded form such that opposite, longitudinally-extending side edge portions of the expanded sheet material are exposed. For example, a width of the roll of interleaf material may be up to about 50% less than a width of the roll of expanded sheet material. However, in some embodiments, the roll of interleaf material may have a width that is substantially the same as a width of the roll of expanded sheet material. As such, embodiments of the present invention may include a roll of interleaf material with a width equal to or about 50% less than a width of a roll of expanded sheet material.

In some embodiments of the present invention, the expandable sheet material includes a slit pattern which forms an array of openings (e.g., hexagonal openings, diamond-shaped openings, etc.) when the expandable sheet material is in an expanded form.

In some embodiments of the present invention, the expanded sheet material and interleaf material are paper sheet materials (e.g., any type of paper, as well as non-woven fibrous sheet materials, woven fibrous sheet materials, etc.) For example, the expanded sheet material may be die-cut slit paper, and the interleaf material may be tissue paper.

According to other embodiments of the present invention, a method of dispensing cushioning wrap material from an unpowered, manually operable apparatus includes concurrently manually pulling interleaf material from a first roll rotatably secured to a frame and expandable sheet material in an unexpanded form from a second roll rotatably secured to the frame while maintaining rotational resistance of the second roll such that the expandable sheet material expands to a proper expanded form in thickness and in length, and such that the interleaf material and expandable sheet material in expanded form are in abutting face-to-face contact. The rotational resistance of the second roll of expandable sheet material can be adjusted via a tensioning assembly that is operably associated with the second roll and the frame such the expandable sheet material in its expanded form has a desired width.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a front perspective of an apparatus for dispensing cushioning wrap material, according to some embodiments of the present invention.

FIG. 2 is a side perspective view of the apparatus of FIG. 1 with the roll of interleaf material and roll of expandable sheet material omitted.

FIG. 3 is a side perspective view of the apparatus of FIG. 1 opposite that from FIG. 2.

FIG. 4A is an exploded perspective view of the apparatus of FIG. 1.

FIG. 4B is a perspective view of the apparatus of FIG. 4A illustrating the roll of interleaf material secured to the frame via the pair of brackets and illustrating the roll of expandable sheet material secured to the frame via the supports.

FIG. 5 is a front perspective of an apparatus for dispensing cushioning wrap material, according to other embodiments of the present invention.

### DETAILED DESCRIPTION

The present invention now is described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by +/− twenty percent (20%).

The term “longitudinal centerline”, as used herein, refers to the centerline of a layer of material that divides the lateral width (i.e., from side edge to side edge) of the layer in two equal halves.

The term “unpowered”, as used herein with respect to the dispensing apparatus, means that the apparatus dispensed cushioning wrap material manually and without the aid of electrical or other sources of power.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

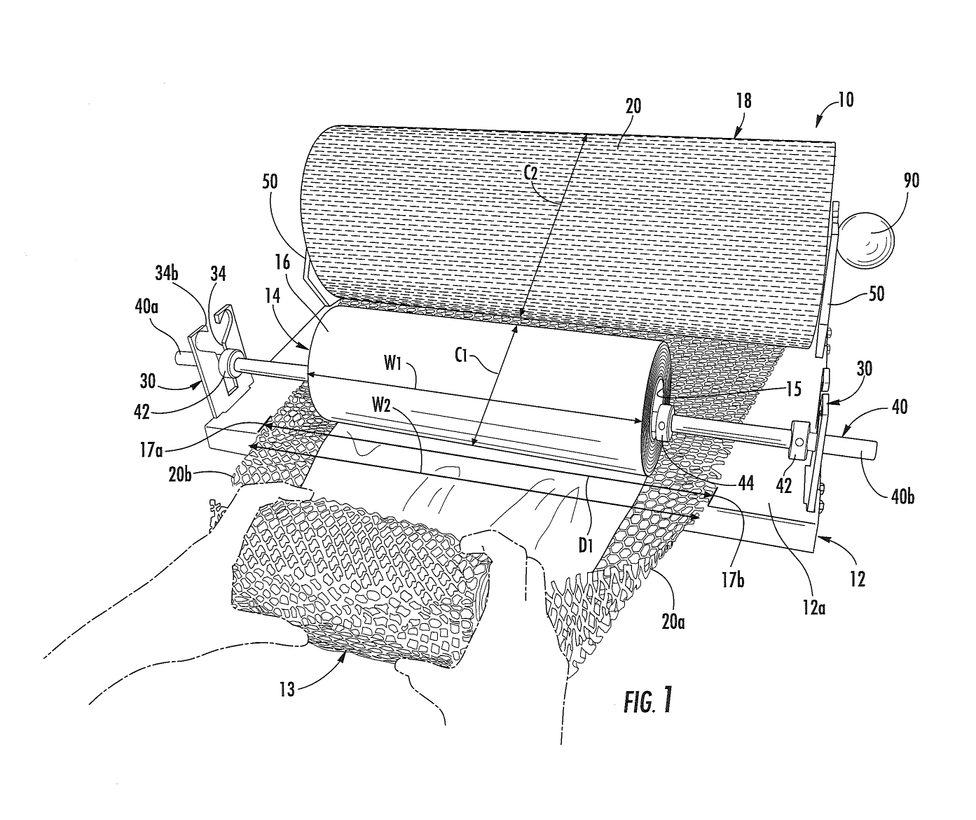

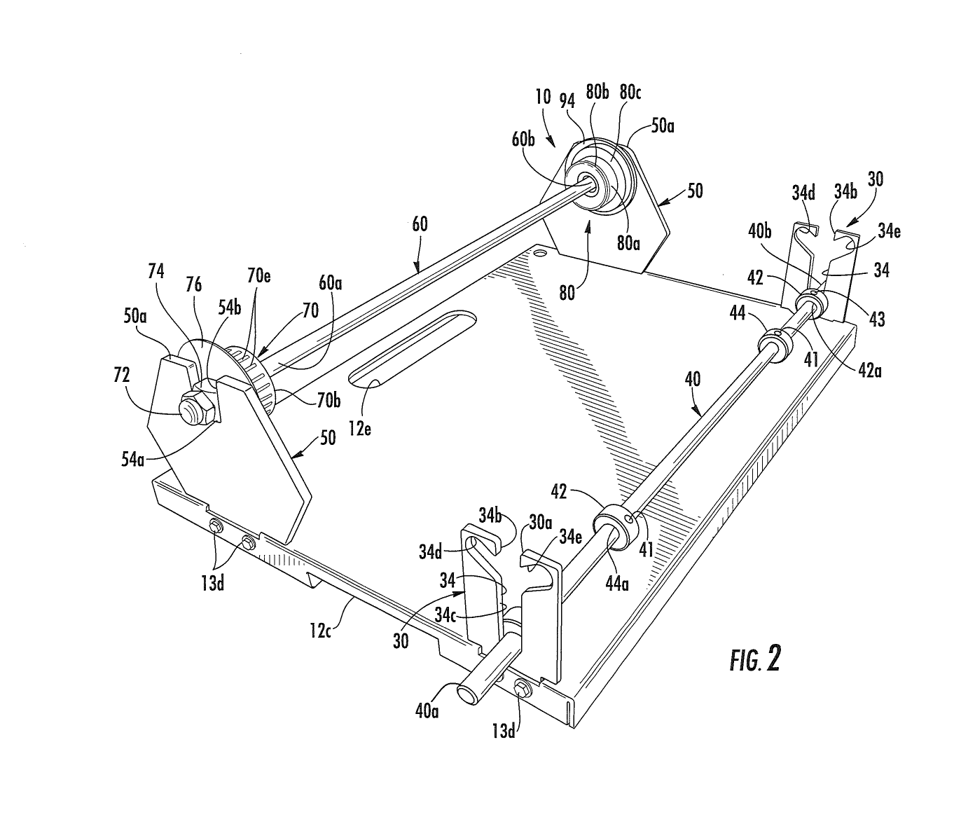

Referring now to FIGS. 1-3 and 4A-4B, an apparatus 10 for dispensing eco-friendly cushioning wrap material 13, according to some embodiments of the present invention, is illustrated. The apparatus 10 includes a frame 12, a roll 14 of interleaf material 16 rotatably secured to the frame 12, and a roll 18 of expandable sheet material 20 in an unexpanded form rotatably secured to the frame 12 adjacent the roll 14 of interleaf material 16. When dispensed, the expandable sheet material 20 in an expanded form and the interleaf material 16 combined form the cushioning wrap material 13. In the illustrated embodiment, the expandable sheet material includes a slit pattern which forms an array of openings (e.g., hexagonal openings) when the expandable sheet material is stretched to an expanded form.

In some embodiments of the present invention, the expandable sheet material 20 and interleaf material 16 are paper sheet materials. For example, the expanded sheet material 20 may can be a die-cut slit paper, such as described in U.S. Pat. Nos. 5,667,871 and 5,688,578, and the interleaf material can be tissue paper. The expandable sheet material 20 may be any of various types of expandable sheet materials (e.g., any type of paper, as well as non-woven fibrous sheet materials, woven fibrous sheet materials, etc.). The interleaf material 16 may be any of various types of sheet materials (e.g., any type of paper, as well as non-woven fibrous sheet materials, woven fibrous sheet materials, etc.). Embodiments of the present invention are not limited to paper sheet materials. Other sheet materials including, but not limited to, polymeric materials and foil may also be utilized.

Typically, the width W₁ of the roll 14 of interleaf material 16 is less than a width W₂ of the expanded sheet material 20 in an unexpanded and expanded form such that opposite, longitudinally-extending side edge portions 20a, 20b of the expandable sheet material 20 are exposed. For example, in some embodiments of the present invention, the width W₁ of the roll 14 of interleaf material 16 may be up to about 50% less than a width of the roll of expanded sheet material. When an article is wrapped in the cushioning wrap material 13, openings in the exposed edge portions 20a, 20b of the expanded sheet material 20 can interlock with each other to help maintain the cushioning wrap material 13 in a wrapped state. However, in some embodiments, the roll of interleaf material may have a width that is substantially the same as a width of the roll of expanded sheet material. As such, embodiments of the present invention may include a roll 14 of interleaf material 16 with a width W₁ equal to or about 50% less than a width W₂ of a roll 18 of expandable sheet material 20.

The illustrated frame 12 has a generally rectangular shape with opposite front and rear portions 12a, 12b and opposite side portions 12c, 12d. However, embodiments of the present invention are not limited to the rectangular-shaped frame 12. The frame 12 may have various shapes and configurations. The illustrated frame 12 also includes a slot 12e formed therein to facilitate user manipulation of the frame, user carrying of the frame, etc.

A pair of opposing brackets 30 extend upwardly from the frame 12 adjacent the frame front end portion 12a. In some embodiments, each bracket 30 includes opposite end portions 30a, 30b with end portion 30b configured to be inserted within a respective slot 13a formed in the frame 12. End portion 30b of each bracket 30 also includes a pair of threaded openings 32 formed therein. When the bracket end portion 30b is inserted within slot 13a, the threaded openings 32 align with corresponding threaded openings 13c in the respective frame side portions 12c, 12d. Threaded fasteners 13d, such as bolts or screws, threadingly engage the aligned threaded openings 13c, 32 to secure each bracket 30 to the frame 12. However, other ways of attaching the brackets 30 to the frame 12 may be utilized such as, but not limited to, press fit, welding, brazing, adhesives, and the like. Moreover, in some embodiments of the present invention, the frame 12, brackets 30, and supports 50 (described below) may be formed as a single structure, such as a unitary monolithic molded polymeric body.

In some embodiments, each bracket 30 includes an upwardly extending elongated slot 34 with a closed end 34a and an opposite open end 34b. Each slot 34 includes a first portion 34c that extends upwardly from the closed end 34a, and second and third portions 34d, 34e adjacent the open end 34b that are angled relative to the first portion 34c. As will be described below, during use of the apparatus 10, each slot 34 is configured to inhibit unintentional disengagement or removal from the frame 12 of the rod 40 that supports the roll 14 of interleaf material 16. However, other ways of preventing unintentional disengagement or removal from the frame 12 of the rod 40 may be utilized, such as a locking mechanism placed over the open upper end 34b of bracket slot 34, etc.

The roll 14 of interleaf material 16 includes a hollow, axially-extending core 15 and is supported on the frame 12 by an elongated rod 40 that extends through the hollow core 15. The rod 40 includes opposite end portions 40a, 40b. The roll 14 of interleaf material 16 is attached to the frame 12 by lowering each end portion 40a, 40b of the rod 40 through the open end 34b of a respective bracket slot 34. The rod 40 includes a first pair of spaced-apart stops 42 that limit axial movement of the rod 40 relative to the brackets 30. Each stop 42 in the illustrated embodiment is generally cylindrical and has a hollow, axially-extending core 42a through which the rod 40 can be inserted. Each stop 42 can be secured to the rod 40 via a set screw 43 that threadingly engages a threaded passage 41 in the stop 42, as would be understood by one skilled in the art. Accordingly, the position of each stop 42 on the rod 40 can be user adjustable.

The illustrated rod 40 also includes a second pair of spaced-apart stops 44 that are located between the first pair of stops 42. The stops 44 are configured to limit axial movement of the roll 14 of interleaf material 16 supported by the rod 40. Similar to stops 42, each stop 44 is generally cylindrical and has a hollow, axially-extending core 44a through which the rod 40 can be inserted. Each stop 44 is secured to the rod 40 via a set screw 43 that threadingly engages a threaded passage 41 in the stop 44, as would be understood by one skilled in the art. Accordingly, the position of each stop 44 on the rod 40 can be user adjustable. Typically, the stops 44 are positioned on the rod 40 such that the longitudinal centerline C₁ of the roll 14 is substantially aligned with a longitudinal centerline C₂ of the roll 18.

During use of the apparatus 10, when a user pulls the interleaf material 16 from the roll 14, the rod 40 may have the tendency to rise upwardly in the slots 34 of brackets 30. The configuration of each slot 34, specifically the slot portions 34d, 34e are configured to trap a respective end portion 40a, 40b of the rod 40, thereby inhibiting unintentional removal of the rod 40 and roll 14 of interleaf material 16 from the frame 12.

A pair of supports 50 extend upwardly from the frame 12 adjacent the frame rear end portion 12b. In some embodiments, each support 50 includes opposite end portions 50a, 50b with the end portion 50b configured to be inserted within a respective slot 13b formed in the frame 12. End portion 50b of each support 50 also includes a pair of threaded openings 52 formed therein. When the support end portion 50b is inserted within slot 13b, the threaded openings 52 align with corresponding threaded openings 13c in the respective frame side portions 12c, 12d. Threaded fasteners 13d, such as bolts or screws, threadingly engage the aligned threaded openings 13c, 52 to secure each support 50 to the frame 12. However, other ways of attaching the supports 50 to the frame 12 may be utilized such as, but not limited to, press fit, welding, brazing, adhesives, and the like. As described above, in some embodiments of the present invention, the frame 12, brackets 30, and supports 50 may be formed as a single structure, such as a unitary monolithic molded polymeric body.

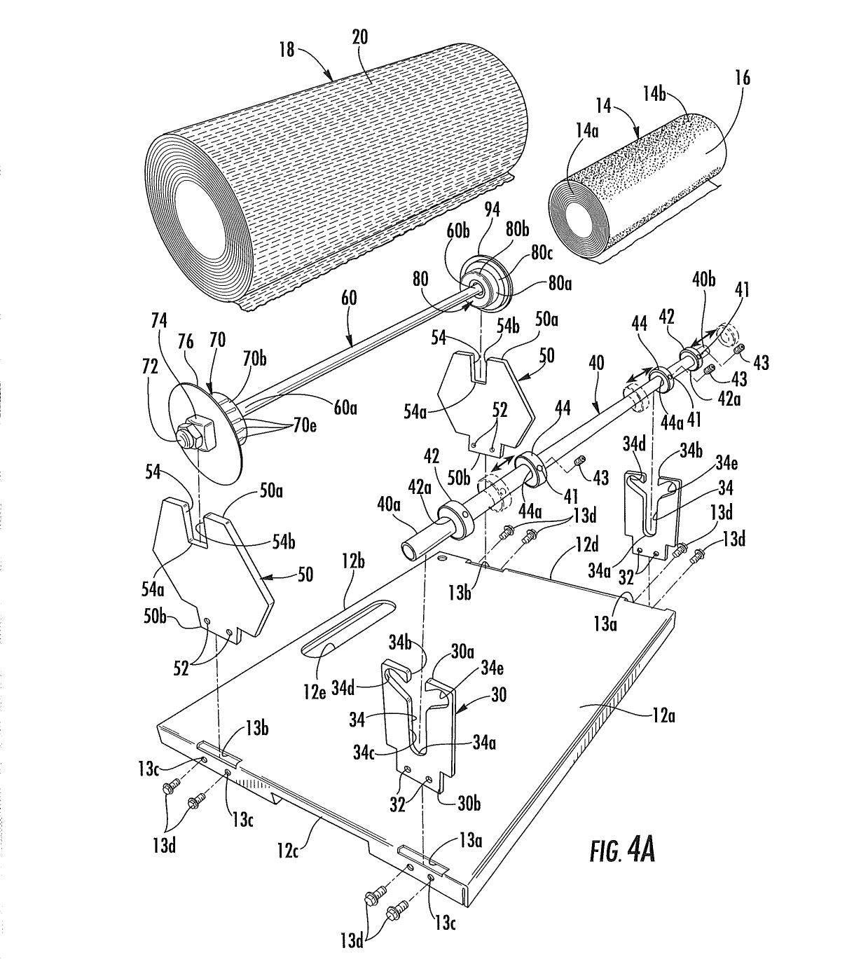

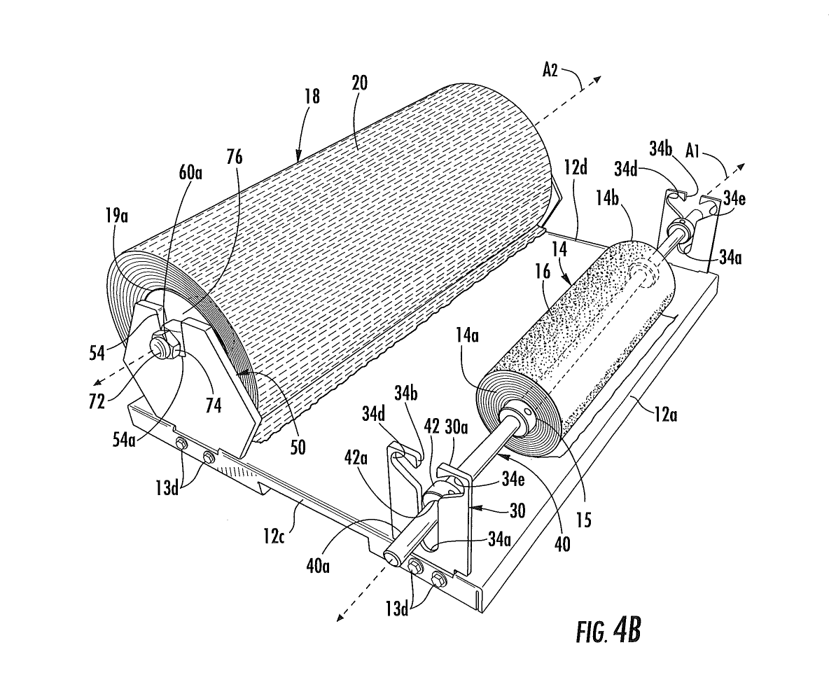

Each support 50 includes a slot 54 formed therein with a closed end 54a and an opposite open end 54b. Each slot 54 is configured to receive a respective end portion 60a, 60b of an elongated rod 60 that rotatably supports the roll 18 of expandable sheet material 20. The end portions 60a, 60b are threaded to threadingly engage an adjustment knob 90 and a pair of nuts 72, 74, as described below. The supports 50 are arranged on the frame 12 relative to the brackets 30 such that the axial directions A₁, A₂ (FIG. 4B) of the rolls 14, 18 are substantially parallel.

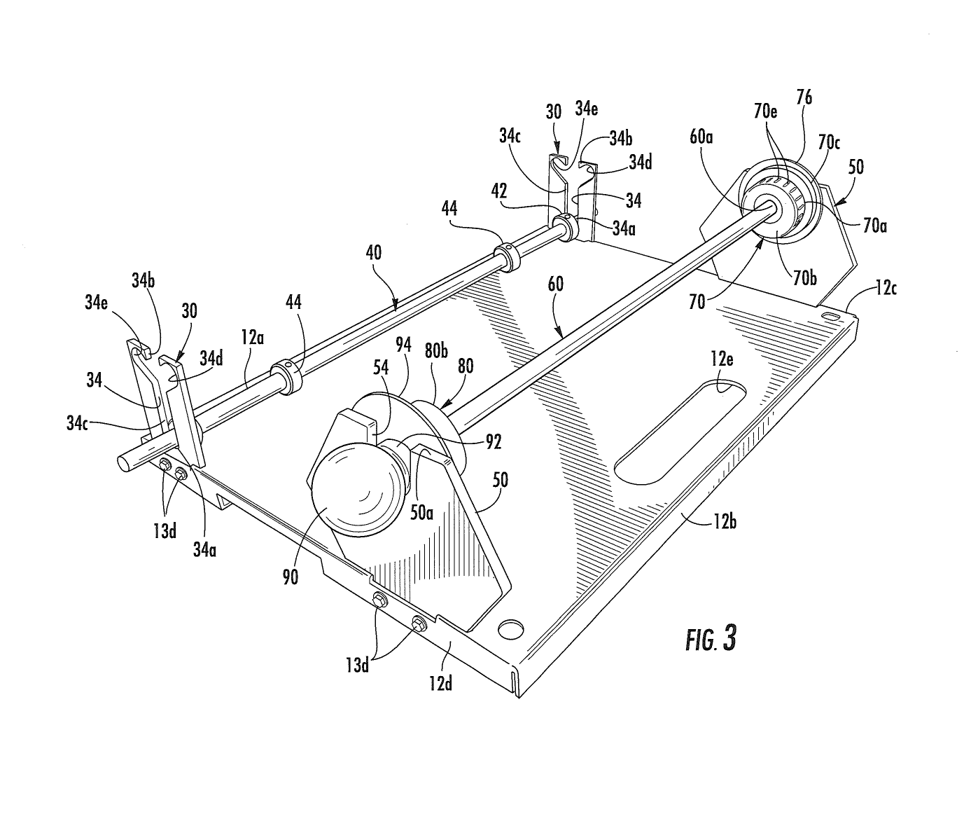

The roll 18 of expandable sheet material 20 has a hollow, axially-extending core 19 through which the elongated rod 60 extends. In some embodiments, as shown in FIGS. 4A and 4B, for example, a first core plug 70 is attached to rod end portion 60a and includes opposite first and second end portions 70a, 70b, and a radially outwardly directed flange 70c (FIG. 3) adjacent the first core plug first end portion 70a. The first core plug second end portion 70b extends into a first end 19a of the hollow core 19 of the roll of expandable sheet material 20. The first core plug 70 can also include a plurality of elongated raised portions 70e in circumferentially-spaced apart relationship, as illustrated, that grip the hollow core 19 of the roll 18. The roll 18 of expandable sheet material 20 is allowed to rotate on the first and second core plugs 70 and 80. Alternatively, either or both core plugs 70, 80 may rotate within the roll 18 of expandable sheet material 20 and either or both core plugs 70, 80 may rotate on the elongated rod 60.

A second core plug 80 is attached to an opposite end portion 60b of the rod 60 and includes opposite first and second end portions 80a, 80b, and a radially outwardly directed flange 80c adjacent the first end portion 80a. The second core plug second end portion 80b extends into an opposite end 19b of the hollow core 19 of the roll of expandable sheet material 18.

In some embodiments, an adjustment knob 90 is threadingly engaged with the rod end portion 60b. User rotation of the knob 90 causes the second core plug 80 to move further into the hollow core of the roll 18 and thereby exert a compressive force on the roll 18 of expandable sheet material 20. As such, a user can control rotational resistance of the roll 18 of expandable sheet material 20 by rotation of the knob 90. The knob 90, rod 60, and first and second core plugs 70, 80 together serve the function of a tensioning assembly.

Specifically, in the illustrated embodiment, user rotation of the adjustment knob 90 advances the knob 90 down the threaded end 60b of the rod 60. As the knob 90 advances, it contacts and presses on a bearing 92. The bearing 92 prevents rotation of the roll 18 from causing the knob 90 to further tighten or to loosen while dispensing expandable sheet material 20. As the knob 90 presses on the bearing 92, the bearing 92 presses on a large flat washer 94. The large flat washer 94 serves to evenly distribute the force resulting from the advancing knob 90. The second core plug 80 then pushes on the roll 18 of expandable sheet material 20. The internal forces cause friction between the surfaces that inhibit the rotation of the roll 18.

The opposite end 60a of the rod 60 includes threads. The rod 60 is terminated with an acorn nut 72 and a square nut 74 that threadingly engage the threaded end 60a. The acorn nut 72 and the square nut 74 are tightened against each other so that they and the rod 60 are all rigidly attached to each other. Adjacent to the square nut 74 is a large flat washer 76 that evenly distributes the force resulting from tightening the adjustment knob 90 on the opposite end of the roll 18 of expandable sheet material 20. The square nut 74 is received by the square slot 54 in the bracket 50 and prevents the rod 60 and the other components rigidly attached to it from free spinning when the expandable sheet material 20 is dispensed from the roll 18.

The frame 12, brackets 30, and supports 50 may be formed from various materials suitable to provide a substantially rigid base for operation of the rolls 14, 18 of interleaf material 16 and expandable sheet material 20. Exemplary materials include, but are not limited to, iron, steel, carbon steel, alloy steel, stainless steel, aluminum, and/or any combination and/or alloys thereof. Other exemplary materials include plastic and wood. Similarly, the rods 40, 60 may be formed from various materials suitable to provide a substantially rigid member upon which the rolls 14, 18 of interleaf material 16 and expandable sheet material 20 can rotate. Exemplary materials include, but are not limited to, iron, steel, carbon steel, alloy steel, stainless steel, aluminum, and/or any combination and/or alloys thereof. Other exemplary materials include plastic and wood. Moreover, the rods 40, 60 may be hollow or solid.

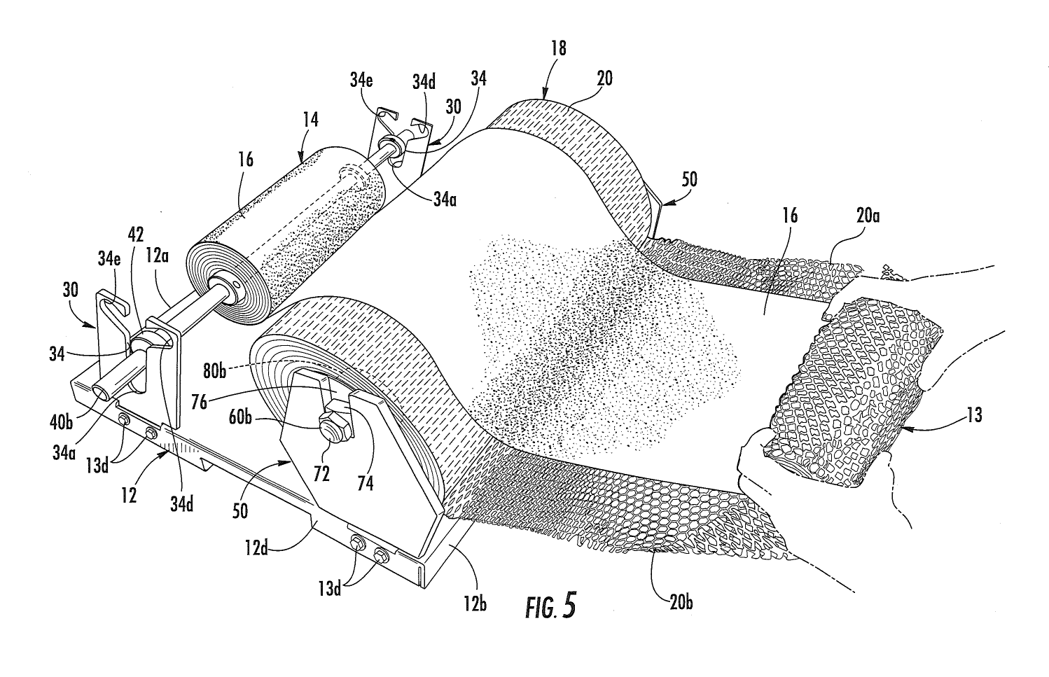

In the illustrated embodiment of FIGS. 1-3 and 4A-4B, the brackets 30 and supports 50 are arranged on the frame 12 such that the roll 14 of interleaf material 16 is adjacent the front end 12a of the frame 12 and such that the roll 18 of expandable sheet material 20 is adjacent the rear end 12b of the frame. However, in other embodiments, this orientation can be reversed. For example, as illustrated in FIG. 5, the brackets 30 and supports 50 are arranged on the frame 12 such that the roll 14 of interleaf material 16 is adjacent the rear end 12b of the frame 12 and such that the roll 18 of expandable sheet material 20 is adjacent the front end 12a of the frame.

In operation, as illustrated in FIGS. 1 and 5, a user simultaneously manually pulls the interleaf material 16 and the expandable sheet material 20 while maintaining rotational resistance of the roll 18 of expandable sheet material 20 such that the expandable sheet material 20 expands to an expanded form in thickness and in length. The user then wraps an article with the cushioning wrap material 13 formed by the combined interleaf material 16 and the expanded sheet material 20 so as to provide protection during packing and shipping.

As illustrated in FIG. 1, in some embodiments of the present invention, the frame 12 includes spaced-apart first and second visual indicia 17a, 17b adjacent the frame front portion 12a. A distance D₁ between the first and second visual indicia 17a, 17b corresponds to a desired width W₁ of the expandable sheet material 20 as it is pulled from the roll 18 in a proper expanded shape. If the width of the expandable sheet material 20 as it is pulled from the roll 18 is greater than W₁, then the material 20 is not in proper expanded form. Additional rotational resistance to the roll 18 is necessary to reduce the width to W₁, and this is accomplished via clockwise rotation of the adjustment knob 90, as described above. If the material 20 tears as it is being pulled from the roll 18, then too much rotational resistance has been applied to the roll 18. The rotational resistance is lessened by counterclockwise rotation of the adjustment knob 90, as described above.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. An unpowered, manually operable apparatus for dispensing cushioning wrap material, the apparatus comprising:
a frame;
a roll of interleaf material rotatably secured to the frame;
a roll of expandable sheet material in an unexpanded form rotatably secured to the frame adjacent the roll of interleaf material such that respective longitudinal centerlines of each roll are substantially aligned; and
a tensioning assembly operably associated with the roll of expandable sheet material to control rotational resistance thereof, wherein the rotational resistance causes the expandable sheet material to expand in length and thickness as it is pulled with the interleaf material manually by a user.

2. The apparatus of claim 1, wherein the frame comprises a pair of opposing brackets extending upwardly from the frame, each bracket having an open ended, elongated slot formed therein, wherein a respective end portion of an elongated rod is received within each slot, and wherein the roll of interleaf material is supported by the rod.

3. The apparatus of claim 2, wherein the rod includes a first pair of spaced-apart stops that limit axial movement of the rod when the rod ends are received within the bracket slots.

4. The apparatus of claim 3, wherein the rod includes a second pair of spaced-apart stops located between the first pair of stops, wherein the second pair of stops limit axial movement of the roll of interleaf material supported by the rod.

5. The apparatus of claim 2, wherein the open end of each bracket slot is configured to inhibit unintentional removal of a respective rod end portion from the bracket slot.

6. The apparatus of claim 1, wherein the tensioning assembly has an adjustment mechanism to control rotational resistance of the roll of expandable sheet material.

7. (canceled)

8. The apparatus of claim 1, wherein the frame includes a pair of supports extending from the fram;
the roll of expandable sheet material comprises a hollow, axially-extending core, and
wherein the tension assembly comprises:
an elongated rod that extends through the hollow core, the elongated rod having opposite end portions, each end portion secured to a respective one of the supports;
a first core plug attached to one end portion of the rod, the first core plug comprising opposite first and second end portions, and a radially outwardly directed flange adjacent the first core plug first end portion, wherein the first core plug second end portion extends into one end of the hollow core;
a second core plug attached to an opposite end portion of the rod, the second core plug comprising opposite first and second end portions, and a radially outwardly directed flange adjacent the second core plug first end portion, wherein the second core plug second end portion extends into an opposite end of the hollow core; and
an adjustment mechanism operably associated with the second core plug that is configured to exert a compressive force on the roll of expandable sheet material to thereby control rotational resistance of the roll of expandable sheet material.

9. The apparatus of claim 1, wherein axial directions of the rolls are substantially parallel.

10. The apparatus of claim 1, wherein a width of the roll of interleaf material is the same or less than a width of the roll of expandable sheet material.

11. The apparatus of claim 1, wherein the expandable sheet material comprises a slit pattern which forms an array of openings when the expandable sheet material is in an expanded form.

12. The apparatus of claim 1, wherein the expanded sheet material and interleaf material are paper sheet materials.

13. The apparatus of claim 1, wherein the expanded sheet material is die-cut slit paper, and wherein the interleaf material is tissue paper.

14. The apparatus of claim 1, wherein the frame comprises spaced-apart first and second visual indicia, wherein a distance between the first and second visual indicia corresponds to a desired width of the expandable sheet material as it is dispensed in a proper expanded shape.

15. An unpowered, manually operable apparatus for dispensing cushioning wrap material, the apparatus comprising:
a frame;
a pair of opposing brackets extending upwardly from the frame, each bracket having an open ended, elongated slot formed therein;
a roll of interleaf material comprising a hollow, axially-extending core, wherein the roll of interleaf material is rotatably secured to the frame via an elongated rod extending through the core, wherein the elongated rod comprises opposite end portions, each end portion received within a respective slot, and wherein the open end of each bracket slot is configured to inhibit unintentional removal of a respective rod end portion from the bracket slot;
a roll of expandable sheet material in an unexpanded form rotatably secured to the frame adjacent the roll of interleaf material such that respective longitudinal centerlines of each roll are substantially aligned; and
a tensioning assembly operably associated with the roll of expandable sheet material to control rotational resistance thereof, wherein the rotational resistance causes the expandable sheet material to expand in length and thickness as it is pulled with the interleaf material by a user.

16. The apparatus of claim 15, wherein the rod comprises a first pair of spaced-apart stops that limit axial movement of the rod relative to the brackets, and a second pair of spaced-apart stops located between the first pair of stops, wherein the second pair of stops limit axial movement of the roll of interleaf material supported by the rod.

17. The apparatus of claim 15, wherein the tensioning assembly has an adjustment mechanism to control rotational resistance of the roll of expandable sheet material.

18. (canceled)

19. The apparatus of claim 15, wherein the roll of expandable sheet material comprises a hollow, axially-extending core, and wherein the tension assembly comprises:
an elongated rod that extends through the hollow core, the elongated rod having opposite end portions, each end portion secured to a respective one of the brackets;
a first core plug attached to one end portion of the rod, the first core plug comprising opposite first and second end portions, and a radially outwardly directed flange adjacent the first core plug first end portion, wherein the first core plug second end portion extends into one end of the hollow core;
a second core plug attached to an opposite end portion of the rod, the second core plug comprising opposite first and second end portions, and a radially outwardly directed flange adjacent the second core plug first end portion, wherein the second core plug second end portion extends into an opposite end of the hollow core; and
an adjustment mechanism operably associated with the second core plug that is configured to exert a compressive force on the roll of expandable sheet material to thereby control rotational resistance of the roll of expandable sheet material.

20. (canceled)

21. (canceled)

22. (canceled)

23. The apparatus of claim 15, wherein the frame comprises spaced-apart first and second visual indicia, wherein a distance between the first and second visual indicia corresponds to a desired width of the expandable sheet material as it is dispensed in a proper expanded shape.

24. A method of dispensing cushioning wrap material from an unpowered apparatus, the method comprising concurrently manually pulling interleaf material from a first roll rotatably secured to a frame and expandable sheet material in an unexpanded form from a second roll rotatably secured to the frame while maintaining rotational resistance of the second roll such that the expandable sheet material expands to a proper expanded form in thickness and in length, and such that the interleaf material and expandable sheet material in expanded form are in abutting face-to-face contact.

25. The method of claim 24, further comprising adjusting the rotational resistance of the second roll of expandable sheet material via a tensioning assembly operably associated with the second roll and the frame such the expandable sheet material in its expanded form has a desired width.

26. (canceled)

27. (canceled)

28. The method of claim 24, wherein the frame comprises spaced-apart first and second visual indicia, wherein a distance between the first and second visual indicia corresponds to a desired width of the expandable sheet material in a proper expanded shape, and further comprising adjusting the rotational resistance of the second roll of expandable sheet material via a tensioning assembly operably associated with the second roll and the frame such the expandable sheet material in its expanded form has a width that is substantially the same or less than the distance between the first and second visual indicia.
